(19) United States
(12) Patent Application Publication
(10) Pub. No.: US 2010/0316442 A1
(43) Pub. Date: Dec. 16, 2010

(54) In-line coupling pipe

(76) Inventors: Randall A. Kolbet, Hamilton, OH (US); Kevin M. Miller, Marysville, OH (US)

Correspondence Address: Patrick P. Phillips;KREMBLAS, FOSTER, PHILLIPS & POLLICK, 7632 Slate Ridge Blvd., Reynoldsburg, OH, 43068, US

(21) Appl. No.: 12/456,252

(22) Filed: Jun. 12, 2009

(51) Int. Cl. F16D 1/00; F16L 19/00

(52) U.S. Cl. 403/361; 285/374

(57) ABSTRACT

An in-line coupling pipe is provided having a plurality of first corrugations with a male portion at one end of the pipe and a female portion at the other end. The diameter at the crest of the first corrugation being a first distance. The male portion having a second corrugation with the diameter at the crest of the second corrugation being a second distance. The male portion of having a third corrugation intermediate the first corrugation and the second corrugation, with the diameter at the crest of the third corrugation being a third distance. The male portion having a fourth corrugation intermediate the first corrugation and the third corrugation, with the diameter at the crest of the fourth corrugation being a fourth distance, with the first distance being greater than the second or third or fourth distances, the second distance being greater than the third distance, and the fourth distance being greater than second or third distances. The second corrugation has a recess formed therein.

### BACKGROUND OF THE INVENTION

1. Field of the Invention

This invention relates generally to pipe, and more particularly to an in-line coupling pipe that allows intentional misalignment of a pipe joint without flexing or deformation of the pipe.

2. Description of the Related Art

This invention is directed to the providing of a pipe of the type used in the drainage of soil for agricultural, commercial, residential, or recreational purposes, including but not limited to sanitary, storm sewer, and agricultural irrigation uses. Historically, concrete, smooth wall plastic and fiberglass pipe were utilized.

In practice, the irrigation, sanitary, or drainage pipe was installed through the placing together of relatively short sections of the pipe to construct the desired drainage, sanitary, or irrigation system. Such sections or pieces would typically be a few feet long. Consequently, construction was extremely time consuming and relatively expensive because of the number of pieces and total weight associated with the components of the drainage system. Joints for such systems also required that there be little or no joint offset. Additionally, the relatively large number of pipes which were required to be installed for such systems necessitated proper positioning of an extremely large number of pipes in order to insure minimal leakage or none at all. This also required joints with proper control of offsets to hold length and pressure tolerances.

More recently, plastic began to be used as a construction material for drainage, sanitary, and irrigation pipe. Originally, sections of the plastic pipe or tubing were provided in predetermined lengths or sections which then were interconnected by using separate couplers or coupling units. Consequently, it became necessary to dig a trench wide enough to accommodate the diameter of the installed coupler which was typically of a dimension greater than that of the pipe itself. This meant that additional ground needed to be disturbed and additional fill needed to be replaced, both of which factors would drive up the cost of installation. Alternately, the trench could be widened just at the location of the installed coupler. However, this would require additional digging, which of course would be time consuming and drive up the cost of installation.

Less than a decade ago, inventions in pipe construction resulted in in-line bell pipe which permitted less soil to be disturbed and easier laying of pipe. Additionally, improvements in plastic pipe construction permitted such pipe to be used in more storm and sanitary sewer applications due to this type of pipe being able to meet standards concerning leakage. However, without the ability for the joint to articulate, the use of the pipe for various applications was limited. One proposed solution to the problem was the manufacture of custom fabricated fittings, bends or joints, however, such structures, depending on the size of pipe involved, could easily cost $1000-2500 per fitting. Therefore, while in theory a solution to the problem existed, practically speaking the solution was cost prohibitive.

However, even with this improved pipe construction, misalignment of two adjacent segments of pipe could cause leakage and in some cases an undesirable flexing or deformation of the pipe at the juncture of the two joined segments of pipe. In some cases, such misalignment could be completely accidental and unintended, however in other cases the terrain or curvature associated with the intended path of the pipe could make for a problematic situation. For example, the potential for misalignment is exacerbated in terrain that is hilly, and in terrain that requires the laying of pipe around curves. In these types of situations, existing bell and spigot pipe can typically only permit a slight misalignment on the order of 1° before there is either buckling of the inner wall, or an undesirable deformation of the pipe and the joint, or the pulling out of the gasket from its intended position of providing a seal between the bell and the spigot of directly adjacent pipes. Any of these undesirable situations can compromise the integrity of the drainage system.

It is thus apparent that the need exists for an improved pipe which in addition to having in-line coupling, has such coupling provide an effective seal even where there is misalignment between that pipe and another directly adjacent thereto while maintaining leakage and pressure requirements.

### SUMMARY OF THE INVENTION

In accordance with the present invention, there is disclosed an indeterminate length of pipe comprising at least two corrugated sections of pipe joined by a coupler component, with the coupler component having a male portion and a female portion to connect two of the corrugated sections. Each corrugated section has a plurality of first corrugations, with each of the first corrugations having a crest and a valley and with the diameter of the male portion at the crest of the first corrugation being a first distance. The male portion of each coupler component has a second corrugation, with the second corrugation having a crest and a valley directly adjacent the crest of the second corrugation and with the diameter of the male portion at the crest of the second corrugation being a second distance. The male portion of each coupler component also has a third corrugation intermediate the male portion first corrugation and the second corrugation, with the third corrugation having a crest and a valley directly adjacent the crest of the third corrugation with the diameter of the male portion at the crest of the third corrugation being a third distance. The male portion of each coupler component has a fourth corrugation intermediate the first corrugation and the third corrugation, with the fourth corrugation having a crest and a valley directly adjacent the crest of the fourth corrugation with the diameter of the male portion at the crest of the fourth corrugation being a fourth distance. The first distance is greater than the second or third or fourth distances. The second distance is greater than the third distance. The fourth distance is greater than the second or third distances.

Preferably the pipe is dual-wall pipe. Additionally, preferably the second corrugation has a recess formed therein. In one embodiment of the invention, the male portion includes a fifth corrugation intermediate the second corrugation and the third corrugation, with the fifth corrugation having a crest and a valley directly adjacent the crest of the fifth corrugation and with the diameter of the male portion at the crest of the fifth corrugation being a fifth distance. The fifth distance is less than the first or fourth distances. In this embodiment of the invention, the third distance is preferably less than the fifth distance and the second distance is greater than the fifth distance. The fifth corrugation preferably has a recess formed therein.

One embodiment of the invention also includes a sixth corrugation intermediate the first corrugation and the fourth corrugation, with the sixth corrugation having a crest and a valley directly adjacent the crest of the sixth corrugation and with the diameter of male portion at the crest of the sixth corrugation being a sixth distance. In such an embodiment, the sixth distance is preferably greater than the second, third or fifth distances. More preferably in such embodiment, the sixth distance is greater than the fourth distance, but less than the first distance.

There is also disclosed a connection between two sections of corrugated pipe, with the pipe having a plurality of first corrugations having a crest and a valley directly adjacent thereto, with the diameter of the first corrugations at the crest of the first corrugation being a first distance. The connection has a male portion with the male portion having a second corrugation having a crest and a valley directly adjacent the crest of the second corrugation. The diameter of the male portion at the crest of the second corrugation is a second distance.

The male portion also has a third corrugation intermediate the first corrugation and the second corrugation, with the third corrugation having a crest and a valley directly adjacent the crest of the third corrugation. The diameter of the male portion at the crest of the third corrugation is a third distance. The male portion has a fourth corrugation intermediate the first corrugation and the third corrugation, with the fourth corrugation having a crest and a valley directly adjacent the crest of the fourth corrugation. The diameter of the male portion at the crest of the fourth corrugation is a fourth distance. The first distance is greater than the second or third or fourth distances. Further, the second distance is greater than the third distance, and the fourth distance is greater than the second or third distances. In the preferred embodiment of the invention, the second corrugation has a recess formed therein.

In one embodiment of the invention, the male portion has a fifth corrugation intermediate the second corrugation and the third corrugation. The fifth corrugation has a crest and a valley directly adjacent the crest of the fifth corrugation. The diameter of the male portion at the crest of the fifth corrugation is a fifth distance, with the fifth distance being less than the first or fourth distances. In this embodiment of the invention, the third distance is less than the fifth distance and the second distance is greater than the fifth distance.

The connection in use includes a sealing element. The female portion of the connection has a side wall, an outer wall, and an inner engaging wall, with the sealing element located between the male portion and the inner engaging wall of the female portion. Preferably, the connection has at least one strap encircling and in contacting relationship with the outer wall of the female portion. The connection forms an in-line coupling, and in the preferred embodiment the female portion has at least one corrugation, with the strap located intermediate the female portion side wall and the female portion corrugation.

The male portion of the connection has a male portion engagement edge and the female portion has a female portion pipe edge at the juncture of the female portion side wall and pipe trough immediately adjacent thereto. In use, preferably the male portion engagement edge is in contact with the female portion pipe edge at a first point such that the male portion engagement edge can be aligned at an angle of greater than 3° from the female portion pipe edge, yet with the connection exhibiting no deformation or buckling. The male portion engagement edge can even be aligned at an angle of greater than or equal to 5° from the female portion pipe edge.

The primary objective of this invention is to provide a pipe with in-line coupling that can be misaligned yet still provide an effective seal against the leakage of liquid.

Another objective of this invention is to provide such a pipe that is able to be fabricated using existing technology and easily installed in operative position.

Other objects and advantages of the invention will be apparent from the following description, the accompanying drawings and the appended claims.

### BRIEF DESCRIPTION OF THE DRAWINGS

FIG. 1 is a vertical sectional view of a portion of a pipe made in accordance with the present invention.

FIG. 2 is a vertical sectional view of a portion of the invention prior to severing the male portion and female portion of the couple component of the invention.

FIG. 3 is a schematic view disclosing the invention in actual use.

In describing the preferred embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose.

### DETAILED DESCRIPTION OF THE INVENTION

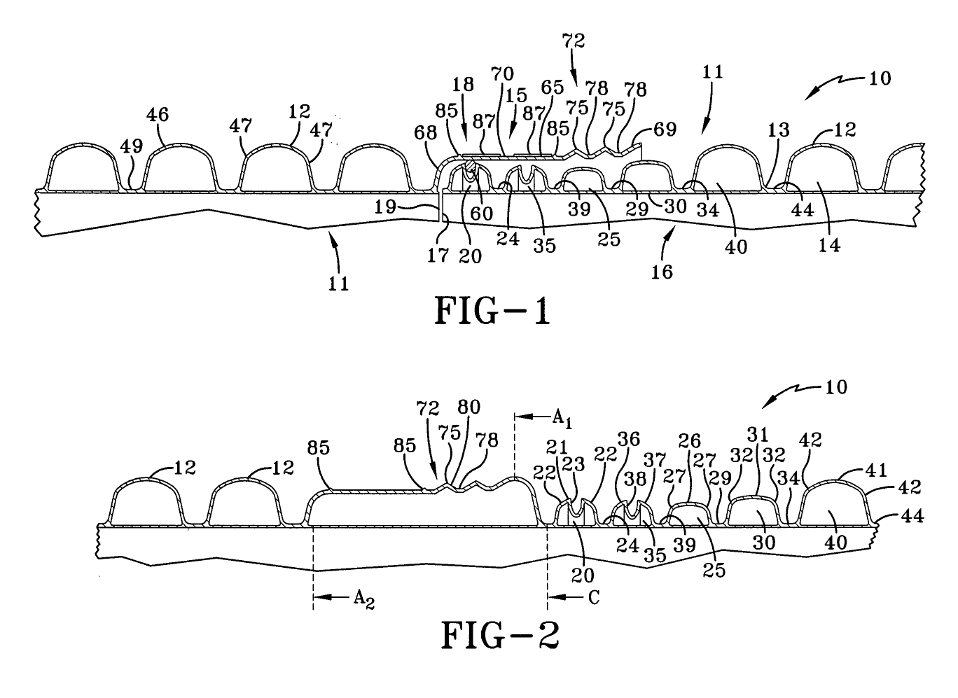

Having reference to the drawings, attention is directed first to a comparison of FIG. 1 which discloses a corrugated pipe of indeterminate length and FIG. 2 which discloses the extruded product prior to being separated into the individual pipe sections 11 of the pipe designated generally by the numeral 10. The pipe sections 11 can be appreciated as having corrugations 12, with the pipe 10 having an outer wall 13 and an inner wall 14. The invention also features a coupler component 15 having a male portion 16 with a male portion engagement edge 17 and a female portion 18 with a female portion pipe edge 19. The pipe 10 is primarily fabricated from plastic, such as HDPE (high density polyethylene) or other extrudable plastics.

As can be appreciated from a comparison of FIGS. 1 and 2, the first corrugations 12 are formed having a crest or peak 46, a side wall 47 and a trough 44 directly adjacent the peaks of the first corrugations, with the side walls 47 connecting the first corrugation peaks and troughs, and with the diameter or cross-sectional diameter at the crests of the first corrugations 12 being a first distance.

Meanwhile, it will be appreciated that the male portion 16 is formed having a second corrugation 20 directly adjacent the male portion engagement edge 17. The second corrugation has a peak 21 and a side wall 22 on each side of the peak. Furthermore, in the preferred embodiment of the invention, the second corrugation has a recess 23 formed therein adjacent to the peak 21. The second corrugation 20 also has a trough 24 directly adjacent the side wall 22 of the second corrugation. The diameter or cross-sectional diameter of the male portion at the crest 21 of the second corrugation is a second distance. The second distance is less than the first distance.

The male portion 16 also has a third corrugation 25 intermediate the first and second corrugations 12 and 20 respectively. This third corrugation 25 has a crest or peak 26 with a side wall 27 on each side of the peak 26. Further, the side wall on the side of the third corrugation 25 nearest the first corrugation 12 is connected to a trough 29. The diameter or cross-sectional diameter of the male portion at the crest of the third corrugation is a third distance. This third distance is less than each of the first and second distances.

The male portion 16 also has a fourth corrugation 30 intermediate the first and third corrugations 12 and 25 respectively. This fourth corrugation 30 has a crest or peak 31 with a side wall 32 on each side of the peak 31. The fourth corrugation 30 has a side wall on the side of the fourth corrugation 30 nearest the first corrugation 12 connected to a trough 34. The diameter or cross-sectional diameter of the male portion at the crest of the fourth corrugation is a fourth distance. This fourth distance is less than the first distance, but greater than the third distance as well as the second distance.

In one embodiment, the male portion 16 also has a fifth corrugation 35 intermediate the second and third corrugations 20 and 25 respectively. This fifth corrugation 35 has a crest or peak 36 with a side wall 37 on each side of the peak 36. In this embodiment of the invention, preferably the fifth corrugation has a recess 38 formed therein adjacent the peak 36. The fifth corrugation 35 has a side wall on the side of the fifth corrugation 35 nearest the first corrugation 12 connected to a trough 39. The diameter or cross-sectional diameter of the male portion at the crest of the fifth corrugation is a fifth distance. This fifth distance is less than each of the first distance and the second distance, but greater than the third distance.

The male portion 16 can, depending on mold size, have a sixth corrugation 40 intermediate the first and fourth corrugations 12 and 30 respectively. For example, a corrugated pipe having a diameter of 30″ may not require this sixth corrugation. If present, this sixth corrugation 40 has a crest or peak 41 with a side wall 42 on each side of the peak 41. The sixth corrugation 40 has a side wall on the side of the sixth corrugation 40 nearest the first corrugation 12 connected to a trough 44. The diameter or cross-sectional diameter of the male portion at the crest of the sixth corrugation is a sixth distance. This sixth distance is preferably less than the first distance, but greater than each of the second, third, fourth and fifth distances.

In actual use, the structure is formed by extruding both the outer wall 13 and the inner wall 14 together. Air or pressure is used to bring the two walls into contact with one another as is well known in the art of dual wall pipe extrusion. The extruded product is then cut at line C completely through the extruded structure shown in FIG. 2, then the outer wall is cut at line A₁ and the inner wall is cut at line A₂ (which also happens to be the location of the female portion pipe end 19) so as to form the finished male and female portions 16 and 18 respectively.

As formed, each of the first corrugations 12 has a peak 46 with a side wall 47 on each side of the peak. Between directly adjacent first corrugations 12 are troughs 49. Furthermore, as formed, the female portion 18 has a female portion wall member 65 connected to one of the troughs 69 at the end of one of the sections 11 by side wall 68. The female portion wall member 65 has an outer wall 69 as its exterior surface and an engaging wall 70 as its interior surface.

The engaging wall 70 has formed therein at least one engaging wall corrugation or stiffening ring 72 located near the open end of the female portion 18. Associated with the engaging wall corrugation 72 is an engaging wall corrugation peak 75 and engaging wall corrugation trough 78 connected to the engaging wall peak 75 by engaging wall corrugation side wall 80. The outer wall 69 of the female portion wall member 65 also preferably has a rib 85 near the connection with the side wall 68. Another rib is preferably formed on the substantially planar portion of the outer wall 69 near the engaging wall corrugation.

Although it should be realized that the specific dimensions of pipe made in accordance with this invention will vary depending on the actual diameter of the pipe, for purposes of example, for a 36″ diameter pipe, the typical width of a first corrugation from the center of a trough to the center of the next trough is about 5.2″. Similarly, the width of each second and fifth corrugation is slightly less than 3″, while the width of the third corrugation is about 3.1″. Additionally, the width of the fourth corrugation is about 3.7″ and that of the sixth corrugation about 4.9″.

In such a diameter pipe the width of the coupler component from trough to trough is about 13.5″, with the trim out area in the inner wall being about 12.5″ and the trim out area in the outer wall being about 1.95″. The distance between the ribs on the female portion wall member, with this planar section referred to as the wrap area, is about 5″. Furthermore, in a 36″ diameter pipe the height of the first corrugations is about 2.75″, the height of the second corrugation is about 1.55″, the height of the third corrugation is about 1.3″, the height of the fourth corrugation is about 1.6″, the height of the fifth corrugation is about 1.5″, and the height of the sixth corrugation is about 2.6″.

In actual field installation, one pipe section is positioned in the trench dug for it. The next pipe has a sealing member positioned on its spigot, preferably in the recess of the second corrugation, however if desired a gasket can be placed in the recess in both the second and the fifth corrugations. The size and configuration of sealing ring or gasket 60 are of the type that would be well known to one familiar with pipe gaskets.

Although the chosen gasket 60 should be compressed as the male portion is inserted farther into the female portion of the adjacent pipe, as the sealing ring 60 is squeezed between the engaging wall and the corrugation, to maintain a tight seal at least one, and preferably two, straps are secured around the bell. The straps 87 are fabricated from fiberglass strands that are encapsulated in polyethylene, but other straps that accomplish the same objective could be used. The straps prevent the swelling of the bell when the bell is subjected to increased internal pressure that could otherwise cause the seal between the bell and spigot to be compromised. In cases where the diameter of the pipe is more on the order of 48″ or 60″, three straps may be utilized. Regardless of the number of straps used, they are positioned such that they are substantially over a corrugation on the male portion and respective sealing ring, especially the second and fifth corrugations.

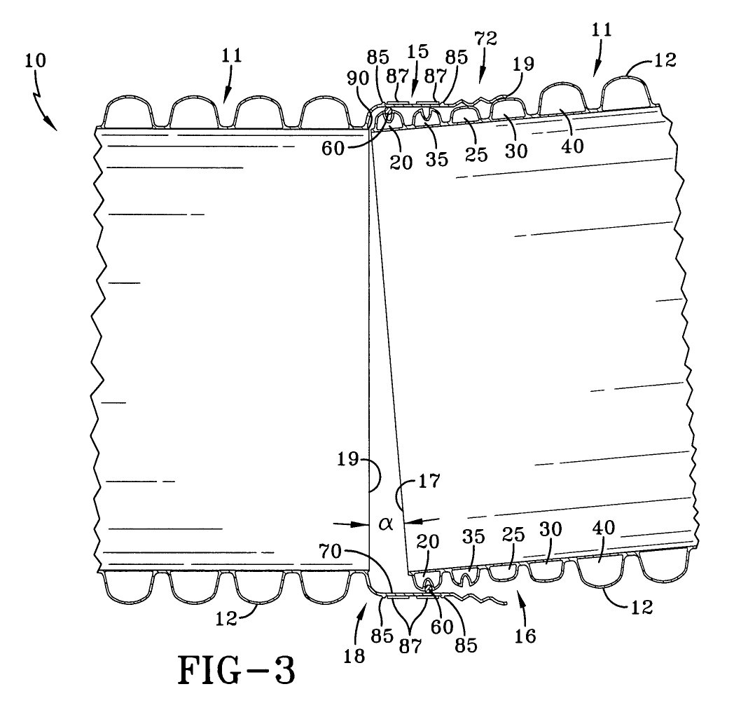

To better appreciate the advantages associated with the invention in actual use, comparison made be had to FIGS. 1 and 3. When the male portion of a pipe is inserted into the female portion of the pipe of this invention, the male portion engagement edge 17 preferably comes into contact with the female portion pipe edge 19 at a contact or first point 90. Theoretically the two edges 17 and 19 are in contacting relationship completely across the pipe. However, as stated above, when the pipe is laid around curves or in hilly locales there can be a slight separation of the edges at an angle α as shown in FIG. 3. Even a very slight separation can cause problems, however due to the structure of this coupling pipe, α can be at least 3° and even 5° or greater without the pipe or its coupling exhibiting any deformation or buckling. Thus, even though the pipe sections are in effect misaligned, this invention withstands the misalignment yet maintains a seal.

While the form of apparatus herein described constitutes a preferred embodiment of the present invention, it is to be understood that the invention is not limited to this precise form of apparatus and that changes may be made therein without departing from the scope of the invention which is defined in the appended claims.

What is claimed is:

1. An indeterminate length of pipe comprising at least two corrugated sections of pipe joined by a coupler component, said coupler component having a male portion and a female portion to connect two of the corrugated sections, each corrugated section having a plurality of first corrugations, each of said first corrugations having a crest and a valley with the diameter of said male portion at said crest of said first corrugation being a first distance, said male portion of each coupler component having a second corrugation, said second corrugation having a crest and a valley directly adjacent said crest of said second corrugation with the diameter of said male portion at said crest of said second corrugation being a second distance, said male portion of each coupler component having a third corrugation intermediate said first corrugation and said second corrugation, said third corrugation having a crest and a valley directly adjacent said crest of said third corrugation with the diameter of said male portion at said crest of said third corrugation being a third distance, said male portion of each coupler component having a fourth corrugation intermediate said first corrugation and said third corrugation, said fourth corrugation having a crest and a valley directly adjacent said crest of said fourth corrugation with the diameter of said male portion at said crest of said fourth corrugation being a fourth distance, said first distance being greater than said second or third or fourth distances, said second distance being greater than said third distance, said fourth distance being greater than said second or third distances.

2. The pipe according to claim 1 wherein said pipe is dual-wall pipe.

3. The pipe according to claim 1 wherein said second corrugation has a recess formed therein.

4. The pipe according to claim 1 which includes a fifth corrugation, said fifth corrugation intermediate said second corrugation and said third corrugation, said fifth corrugation having a crest and a valley directly adjacent said crest of said fifth corrugation with the diameter of said male portion at said crest of said fifth corrugation being a fifth distance, said fifth distance being less than said first or fourth distances.

5. The pipe according to claim 4 wherein said third distance is less than said fifth distance.

6. The pipe according to claim 4 wherein said second distance is greater than said fifth distance.

7. The pipe according to claim 4 wherein said fifth corrugation has a recess formed therein.

8. The pipe according to claim 4 which includes a sixth corrugation, said sixth corrugation intermediate said first corrugation and said fourth corrugation, said sixth corrugation having a crest and a valley directly adjacent said crest of said sixth corrugation with the diameter of said male portion at said crest of said sixth corrugation being a sixth distance, said sixth distance being greater than said second, third or fifth distances.

9. The pipe according to claim 8 wherein said sixth distance is greater than said fourth distance.

10. The pipe according to claim 8 wherein said sixth distance is less than said first distance.

11. A connection between two sections of corrugated pipe, said pipe having a plurality of first corrugations, each of said first corrugations having a crest and a valley directly adjacent thereto, with the diameter of said first corrugations at said crest of said first corrugation being a first distance, said male portion having a second corrugation, said second corrugation having a crest and a valley directly adjacent said crest of said second corrugation with the diameter of said male portion at said crest of said second corrugation being a second distance, said male portion having a third corrugation intermediate said first corrugation and said second corrugation, said third corrugation having a crest and a valley directly adjacent said crest of said third corrugation with the diameter of said male portion at said crest of said third corrugation being a third distance, said male portion having a fourth corrugation intermediate said first corrugation and said third corrugation, said fourth corrugation having a crest and a valley directly adjacent said crest of said fourth corrugation with the diameter of said male portion at said crest of said fourth corrugation being a fourth distance, said first distance being greater than said second or third or fourth distances, said second distance being greater than said third distance, said fourth distance being greater than said second or third distances.

12. The connection according to claim 11 wherein said second corrugation has a recess formed therein.

13. The connection according to claim 11 which includes a fifth corrugation, said fifth corrugation intermediate said second corrugation and said third corrugation, said fifth corrugation having a crest and a valley directly adjacent said crest of said fifth corrugation with the diameter of said male portion at said crest of said fifth corrugation being a fifth distance, said fifth distance being less than said first or fourth distances.

14. The connection according to claim 11 wherein said third distance is less than said fifth distance and said second distance is greater than said fifth distance.

15. The connection according to claim 11 which includes a sixth corrugation, said sixth corrugation intermediate said first corrugation and said fourth corrugation, said sixth corrugation having a crest and a valley directly adjacent said crest of said sixth corrugation with the diameter of said male portion at said crest of said sixth corrugation being a sixth distance, said sixth distance being greater than said second, third or fifth distances.

16. The connection according to claim 11 wherein said sixth distance is greater than said fourth distance and said sixth distance is less than said first distance.

17. The connection according to claim 11 which includes a sealing element, said female portion having a side wall, an outer wall, and an inner engaging wall, said sealing element located between said male portion and said inner engaging wall of said female portion, said connection having at least one strap encircling and in contacting relationship with said outer wall of said female portion.

18. The connection according to claim 11 wherein said male portion has a male portion engagement edge and said female portion has a female portion pipe edge, said male portion engagement edge being in contact with said female portion pipe edge at a first point and said male portion engagement edge aligned at an angle of greater than 3° from said female portion pipe edge, said connection exhibiting no deformation or buckling.

19. The connection according to claim 17 wherein said connection forms an in-line coupling, said female portion having at least one corrugation, said strap located intermediate said female portion side wall and said female portion corrugation.

20. The connection according to claim 18 wherein said male portion engagement edge aligned at an angle of greater than or equal to 5° from said female portion pipe edge.
